(19) United States
(12) Patent Application Publication
(10) Pub. No.: US 2010/0102123 A1
(43) Pub. Date: Apr. 29, 2010

(54) Systems, Methods, and Apparatus for Facilitating Access to Medical Information

(75) Inventor: Daniel P. Skowronek, Parker, CO (US)

Correspondence Address: SUTHERLAND ASBILL & BRENNAN LLP, 999 PEACHTREE STREET, N.E., ATLANTA, GA, 30309, US

(73) Assignee: FIRST DATA CORPORATION, Greenwood Village, CO (US)

(21) Appl. No.: 12/259,647

(22) Filed: Oct. 28, 2008

(51) Int. Cl. G07F 19/00

(52) U.S. Cl. 235/380

(57) ABSTRACT

Embodiments of the invention may relate to systems, methods, and apparatus for facilitating access to medical information. In one embodiment, a method of facilitating access to medical data stored on a contactless transaction device may include transmitting to a contactless transaction device a transaction request comprising either a consumer account transaction type or a medical information transaction type. If the transaction request comprises the consumer account transaction type, the consumer account data may be received from the contactless transaction device, responsive to a determination that the transaction terminal is authorized to receive data associated with the transaction request type. If the transaction request comprises the medical information transaction type, the medical data may be received from the contactless transaction device, responsive to a determination that the transaction terminal is authorized to receive data associated with the transaction request type.

### FIELD OF THE INVENTION

Embodiments of the invention relate generally to contactless transaction devices, and more particularly, to systems, methods, and apparatus for facilitating access to medical information.

### BACKGROUND OF THE INVENTION

A wide variety of conventional cashless transactions are completed utilizing various transaction devices, such as payment instruments associated with a consumer, like credit cards, debit cards, stored value cards, gift cards, etc. Typically, the transaction devices may have a singular purpose, such as providing a credit, debit, or stored value account. Though, in some instances, the transaction device may serve dual purposes, such as serving, as a payment instrument and when serving to accrue, track, and redeem loyalty incentives. In certain instances, some transaction devices may occasionally store more than payment or financial account information.

Emergency medical responders and other medical providers often benefit from knowing certain information about a patient's conditions, such as pre-existing conditions like allergies, medications taken, existing ailments, and the like. Various systems exist for storing indicating to medical personnel a patient's conditions. Examples include bracelets or necklaces having a logo, wording, or other indicia indicating or widely recognizable as relating to certain conditions, and the like. In another example, a bracelet or necklace may have an account number displayed that allows the medical personnel to contact a service provider, such as by placing a telephone call, to retrieve the wearer's conditions. However, these bracelets or necklaces, due to their outward appearance, may not be worn by all individuals who may otherwise desire to provide notification of their medical status. Moreover, these bracelets are not flexible in the amount or type of information that may be stored, and do not provide flexible or efficient access to voluminous, and thus more useful, information by medical personnel.

Therefore, a need exists for systems, methods, and apparatus to facilitate access to medical information. A further need exists for systems, methods, and apparatus to facilitate to medical information for users of a contactless transaction device.

### SUMMARY OF THE INVENTION

Some or all of the above needs and/or problems may be addressed by certain embodiments of the invention. Embodiments of the invention may include systems, methods, and apparatus for facilitating access to medical information. In one embodiment, a contactless transaction device for facilitating access to medical information can be provided. The contactless transaction device may include an antenna operable to electromagnetically receive and transmit data and a microchip in communication with the antenna, the microchip comprising a memory operable to store consumer account data and medical data. In association with a transaction using the contactless transaction device, the microchip may be operable to receive a transaction request from a requester via the antenna, wherein the transaction request may include either a consumer account transaction type or a medical information transaction type and to determine whether the requester is authorized to receive data associated with the transaction request. If the transaction request comprises the consumer account transaction type and if the requester is authorized to receive data associated with the transaction request, the microchip may be operable to transmit the consumer account data from the memory to the requester via the antenna if the transaction request comprises the medical information transaction type and if the requester is authorized to receive data associated with the transaction request, the microchip may be operable to transmit the medical data from the memory to the requester via the antenna.

In another embodiment, a method of transmitting medical data stored on a contactless transaction device can be provided. The method may include providing a contactless transaction device that includes an antenna, and a microchip comprising a memory in communication with the antenna, the memory operable to store consumer account data and medical data. The method may further include receiving a transaction request from a requestor via the antenna wherein the transaction request may include either a consumer account transaction type or a medical information transaction type and determining whether the requestor is authorized to receive data associated with the transaction request. If the transaction request comprises the consumer account transaction type and if the requestor is authorized to receive data associated with the transaction request, the method may further include transmitting the consumer account data from the memory to the requester via the antenna. If the transaction request comprises the medical information transaction type and if the requester is authorized to receive data associated with the transaction request, the method may further include transmitting the medical data from the memory to the requestor via the antenna.

In yet another embodiment, a method of accessing medical data stored on a contactless transaction device can be provided. The method may include transmitting, from a transaction terminal to a contactless transaction device, a transaction request comprising either a consumer account transaction type or a medical information transaction type. If the transaction request comprises the consumer account transaction type, the method may include receiving consumer account data from the contactless transaction device, responsive to a determination that the transaction terminal is authorized to receive data associated with the transaction request type. If the transaction request comprises the medical information transaction type, the method may include receiving medical data from the contactless transaction device, responsive to a determination that the transaction terminal is authorized to receive data associated with the transaction request type.

Additional systems, methods, apparatuses, features, and aspects are realized through the techniques of various embodiments of the invention. Other embodiments and aspects of the invention are described in detail herein and are considered a part of the claimed invention. Other advantages and features can be understood with reference to the description and to the drawings.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example functional block diagram of an example system, according to one embodiment of the invention;

FIG. 2 illustrates an example data flow of an example system and method, according to one embodiment of the invention;

FIG. 3 illustrates an example flowchart of an example method, according to one embodiment of the invention;

FIG. 4 illustrates an example flowchart of an example method, according to one embodiment of the invention;

FIG. 5 illustrates an example flowchart of an example method, according to one embodiment of the invention; and

FIG. 6 illustrates an example flowchart of an example method, according to one embodiment of the invention.

### DETAILED DESCRIPTION OF EMBODIMENTS OF THE INVENTION

Example embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As used herein, the term “contactless transaction device” refers to any suitable device that may be used to store, receive, and transmit medical information, consumer account information, and the like, wirelessly to a requester. For example, a contactless transaction device may be, but is not limited to, a radio frequency identification device (“RFID”), a cellular-based communication device, a Bluetooth enabled device, a Wi-Fi enabled device, an infrared device, and the like, operable to facilitate a consumer transaction, such as a credit transaction, a debit transaction, a stored value transaction, an account inquiry transaction, a loyalty transaction, a medical information transaction, authentication request, verification request, data transmission, data update, and the like. An example contactless transaction device may be configured as a card, a sticker, a key fob, a wristband, or as any other wearable article. Many of the embodiments described herein refer to contactless transaction devices for simplicity; however, other embodiments may use other forms of transaction devices that may not be contactless, such as transaction devices having data stored in a magnetic strip and/or coded on a bar code. Accordingly, where a contactless transaction device is described, another transaction device operable to store data or have data associated therewith may be used.

As used herein, the terms “transaction terminal,” “contactless transaction terminal,” and “terminal” may be used interchangeably, and each may refer to any suitable terminal for transacting with a contactless transaction device (and other transaction devices). For example, a transaction terminal may include, but is not limited to, a point of sale (“POS”) terminal at a retailer or merchant, a handheld terminal, a personal computer, a mobile computer, a handheld portable computer, a digital assistant, a personal digital assistant, a cellular phone, a mobile phone, a smart phone, a pager, a digital tablet, a desktop computer, a laptop computer, an Internet appliance, or any other processor-based device, and the like.

As used herein, the term “transaction request” refers to any request made by a transaction terminal, for example a point of sale terminal, of a contactless transaction device during any type of transaction. For example, the transaction request may be made during a transaction such as, but not limited to, a consumer transaction, for instance, a credit transaction, a debit transaction, a stored value transaction, an account inquiry transaction, a loyalty transaction, a medical information transaction, authentication request, verification request, data transmission, data update, and the like.

As used herein, the term “requestor” refers to any entity, system, device, person, and the like, requesting or attempting to request information from a contactless transaction device. For example, a “requestor” may be, but is not limited to, a transaction terminal, an individual operating the transaction terminal, an individual on whose behalf the transaction terminal is operated, an entity owning, hosting, controlling, or otherwise associated with the transaction terminal.

As used herein, the term “transmitter” refers to any entity, system, device, person, and the like, transmitting or attempting to transmit information to a contactless transaction device. For example, a “transmitter” may be, but is not limited to, a transaction terminal, an individual operating the transaction terminal, an individual on whose behalf the transaction terminal is operated, an entity owning, hosting, controlling, or otherwise associated with the transaction terminal.

In accordance with example embodiments of the invention, systems, methods, and apparatus for facilitating access to medical information using a contactless transaction device are provided. According to one embodiment, a contactless transaction device may be operable to store consumer account data and medical data in memory. The medical data may be medical data that is useful in emergency medical situations, such as data alarming an emergency responder of the device holder's existing medical conditions, allergies, medications, and the like. The contactless transaction device may be a typical payment device, such as a RFID stored value card, RFID credit card, RFID debit card, RFID loyalty card, and the like, operable to facilitate typical consumer transactions with a merchant, for example. In other example embodiments, the contactless transaction device may store one or more identifiers associated with consumer account data and/or medical data stored remotely, such that the memory of the contactless transaction device only stores the identifier which may be used by a requestor to further retrieve that information from the remote location, such as a service provider, merchant system, retailer system, or a financial institution.

An example contactless transaction device configured in this manner, storing both consumer account data and medical data, may serve an additional function of storing the device holder's medical information, making that information available to those authorized to receive it, such as an emergency responder, a physician, a pharmacist, and the like. However, because such medical information may be deemed private and/or sensitive to the user, the contactless transaction device and/or transaction terminals, transmitters, and requesters transacting with the device may be configured to verify one's authority to receive or otherwise access the medical data stored on the contactless transaction device. Thus, when the contactless transaction device is presented in association with a transaction, such as an emergency transaction request for the medical data, one or more of the contactless transaction device, transaction terminal, requestor, and/or transmitter may be operable to determine whether the requestor is authorized to receive the medical data stored on the device. If it is determined that the requestor is authorized to receive the medical data, the contactless transaction device is operable to transmit the medical data from its memory to the requester, such as for use in responding to an emergency, determining appropriate medical treatments to administer, determining who to contact, and the like.

Because the contactless transaction device may operate to facilitate typical consumer transactions as well as transmit medical data, in example embodiments only medical data is transmitted in response to an authorized request for medical data, and only consumer account data is transmitted in response to an authorized consumer account transaction. Thus, an emergency responder will not be permitted to access the device holder's consumer account information, such as account numbers, balances, and the like, and a merchant will not be permitted to access the device holder's sensitive medical information when the device is presented to facilitate a typical consumer transaction, such as a payment transaction.

According to another aspect of the invention, a contactless transaction device containing medical data may be configured to allow one or more parties to enter, update, delete, or otherwise alter the medical data stored thereon. The data entry and/or update transactions may be conducted at a typical transaction terminal, such as from a merchant point of sale device, from a personal computer in direct communication with the contactless transaction device or in communication with a data store over a network, such as the Internet, or telephonically, such as during live communication with a customer service agent or through an automated interactive voice response (“IVR”) system. Again, because the medical data may be considered sensitive and thus private to the device holder, the system may be operable to restrict data entry and/or update transactions to authorized parties.

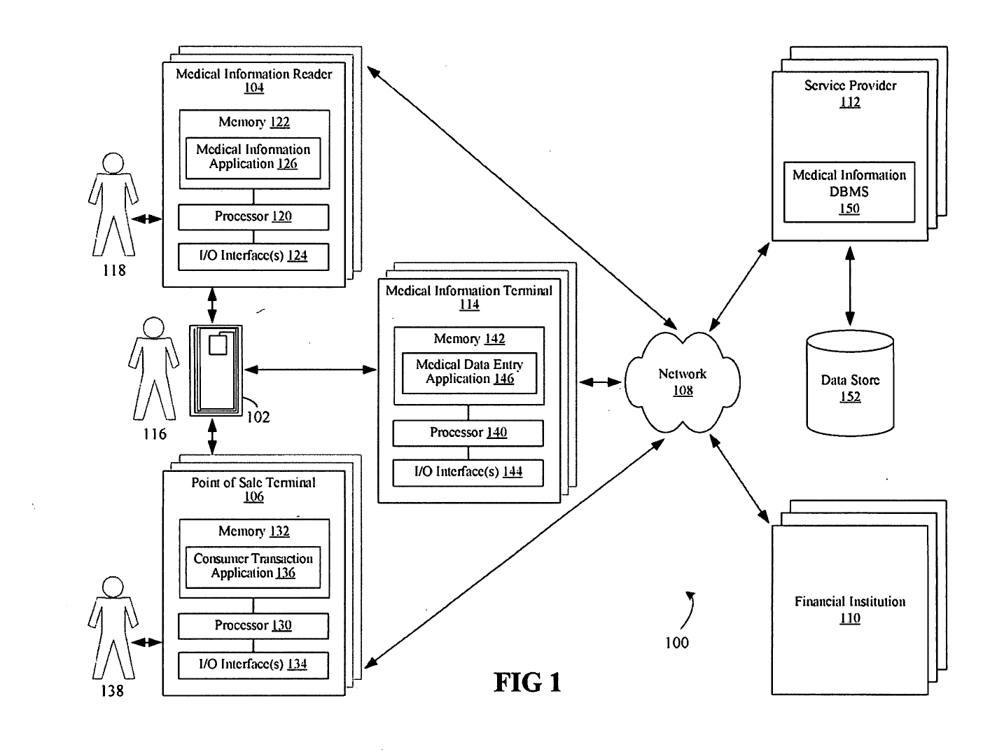

FIG. 1 shows a schematic diagram of one example system 100 and an associated apparatus to facilitate accessing medical information from a contactless transaction device, according to an example embodiment of the invention. The system 100 and/or apparatus may also be utilized to facilitate a consumer account based transaction, such as any suitable payment transaction, for example, a point of sale payment transaction at a merchant or retailer. The system 100 may include a contactless transaction device 102, one or more medical information readers 104 for receiving medical data from the contactless transaction device 102, and one or more point of sale (“POS”) terminals 106 for facilitating a consumer account based transaction with the contactless transaction device, each optionally in communication with a network 108. The system 100 may further include one or more financial institutions 110, and one or more service providers 112, each also optionally in communication the network 108 for transacting with the POS terminals and/or the medical information readers 104, respectively. In one example embodiment, the system 100 may further include one or more medical information terminals 114 for entering and/or updating medical data on the contactless transaction device 102, also optionally in communication with the network 108 and/or the service providers 112.

The contactless transaction device 102 may be any suitable or appropriate device that may be utilized by a device holder, such as device holder 116, to facilitate any transaction wirelessly. In one example embodiment, the contactless transaction device 102 may be a typical payment card, such as a credit card, debit card, or stored value card, that is RFID enabled and has medical data stored thereon in addition to typical consumer account data. In another example embodiment, the contactless transaction device 102 may be used only to store medical data. In yet another example embodiment, the contactless transaction device 102 may be a non-traditional transaction device, such as a personal computer, a mobile computer, a handheld portable computer, a digital assistant, a personal digital assistant, a cellular phone, a mobile phone, a smart phone, a pager, a digital tablet, a desktop computer, a laptop computer, an Internet appliance, or any other processor-based device, and/or configured in a non-traditional configuration, such as a key fob, a wristband, any other wearable article, and the like, having consumer account data and/or medical data stored thereon and operable to facilitate consumer and/or medical information transactions. Although any of the aforementioned example contactless transaction devices 102, or any other suitable transaction devices, may be used and still within the scope of the appended claims, for simplicity a RFID payment card storing both consumer account data and medical data will be referred to in the following description. It is further appreciated that in other embodiments, a transaction device need not be a “contactless” transaction device, and may include the ability to communicate via wired, wireless, optical, and/or magnetic communications, such as a typical payment card having a magnetic strip and/or bar code with consumer account data and/or medical account data stored or encoded thereon. In yet other embodiments, the transaction device may include account indicia displayed on the device, whether or not the transaction device is contactless. For example, the account indicia may be an account number, a card number, or any other unique identifier, as described herein. The account indicia may be printed, embossed, or otherwise displayed on the transaction device. Accordingly, when a transaction device is presented to a transaction terminal or accessed by an emergency responder, at least part of the account may be manually entered, instead of or in addition to conducting a contactless inquiry, allowing for subsequent transactions or communication for remotely stored consumer account data and/or medical data, as may be needed.

An example RFID enabled contactless transaction device 102 may include at least one integrated circuit microchip and at least one antenna or wireless transmitter and/or receiver, for transmitting and/or receiving information associated with a contactless transaction. The microchip and antenna may include circuitry operable to communicate electronic transaction details to a transaction terminal via a contactless reader or another RFID enabled communication device. The microchip includes a memory operable to store consumer account data, medical data, authorization date, and/or any other data. The microchip and memory may also be programmable and writeable such that the data stored thereon may be altered, for example, using a RFID enabled transaction terminal to update medical data.

In example embodiments where the contactless transaction device 102 is a passive RFID device, other RFID enabled devices, including RFID transaction terminals, may provide power to or otherwise energize the microchip via the antenna by induction or via a separate induction loop. In one example embodiment, the antenna both receives signals from a contactless transaction device reader, which may also energize the microchip, and transmits signals from the microchip to a contactless transaction device reader. In other embodiments, however, a separate induction loop may be included with the antenna, to receive signals from a contactless transaction device reader and to energize the microchip. For simplicity, “antenna” as used herein may refer to an antenna, an induction loop, and/or both an antenna and induction loop. In other embodiments, the contactless transaction device 102 may be an active or semi-active device, including a battery or other power source to power the microchip independent of signals received from a transaction terminal.

According to one example embodiment, the microchip and antenna of the contactless transaction device 102 may use any wireless communication methodology and may communicate with radio frequencies. Furthermore, in example embodiments, the information transmitted by the contactless transaction device 102 may conform to any suitable specifications for credit cards, such as PayPass®, Discover Zip®, Visa Contactless®, ExpressPay®, and the like. In example embodiments, the microchip and antenna may be designed to conform to International Organization for Standardization/International Electrotechnical Commission (“ISO/IEC”) standards for contactless transaction cards and proximity cards, including the ISO/IEC 14443 standard and/or the ISO/IEC 15693 standard, among others.

A transaction may be conducted by positioning the contactless transaction device 102 a proximate distance from a contactless transaction terminal capable of transmitting and receiving a signal via the antenna to/from the microchip, such as the medical information reader 104 or the POS terminal 106. Example embodiments may also include having a contactless transaction terminal transmit a signal via the antenna to the microchip, such as a handshake signal, instructing the microchip to start transmitting data that can be used to process the transaction. The handshake may be part of an authorization function to determine that a requestor or a party attempting to store or update data on the microchip is properly authorized. For example, the handshake may include exchanging and/or verification of a public and private key pair. In one example embodiment, when the contactless transaction device 102 conforms to the ISO/IEC 14443 standard, a contactless transaction device reader may send and receive messages via the antenna to/from the microchip via a modulated radio frequency (“RF”) field that has a carrier frequency of approximately 13.56 MHz. Any of the transaction terminals described herein may be operable to communicate with a contactless transaction device 102 following the same, similar, or otherwise conforming standards.

According to one aspect of the invention, consumer account data is stored in the memory of the contactless transaction device 102. Consumer account data may be any data for use in association with or relating to a typical consumer transaction. Example consumer account data may include, but is not limited to, account numbers, account information, expiration dates, balances, limits, transaction histories, account holder name, billing address, shipping address, issuer information, and the like. In one embodiment, the memory of the contactless transaction device 102 stores a unique identifier, such as an account number, which may refer to remote consumer account data associated with the unique identifier and stored remotely. The remote consumer account data may be any of the above-referenced consumer account data, or any other additional account related data. The remotely stored consumer account data may be stored in one or more remote locations, such as a merchant or retailer system, a financial institution 110, which may include a bank, an issuer, and/or a third party payment processor.

Similarly, medical data associated with the device holder 116 (who may be referred to interchangeably as “patient”) may be stored in the memory of the contactless transaction device 102. The medical data may include, but is not limited to, patient medical histories, medical conditions, allergy information, medication information, patient information, physician information, and the like. Much like the consumer account data in one embodiment, the memory of the contactless transaction device 102 may only store one or more unique identifiers, such as a patient identifier, an account identifier, a medical condition identifier, which may refer to remotely stored medical data associated with the unique identifier(s). According to one example embodiment, the remotely stored medical data may be stored and/or maintained by one or more service providers 112, such as a pre-existing provider of medical emergency information (e.g., MedicAlert® Foundation International, Turlock, Calif.; or Philips LifeLine, Andover, Mass.). A contactless transaction device 102 according to one embodiment having medical data stored thereon or otherwise associated therewith may further include identifying indicia that identifies that the contactless transaction device 102 is operable to facilitate access to the device holder's medical data should an emergency occur. The indicia may be any known medically-related symbol, such as the Caduceus, the staff of Asclepius, any written text, trademark, design, shape, pattern, logo, slogan, service mark, or other recognizable indicia.

In one example embodiment, the contactless transaction device 102 may be provided with certain default medical data, such as a default condition, stored thereon. For example, different contactless transaction devices 102 may be provided for different medical conditions, such as one for diabetes, one for specific allergies, one for heart conditions, and the like. Accordingly, the device holder 116 may purchase a contactless transaction device 102 predefined for their specific medical condition. In another embodiment, the contactless transaction device 102 may be purchased without any medical data, and may be updatable by the device holder 116, for example at a transaction terminal at a retailer or from a personal computer in communication with the contactless transaction device 102. In addition, as described herein, the contactless transaction device 102 may also include consumer account data for conducting a typical consumer transaction, such as a stored value account and balance, and may be purchased with a pre-stored default or updatable medical condition in addition to a stored value account and balance.

In example embodiments, the contactless transaction device 102 may facilitate determining the authority of information requestors or parties attempting to store data on the contactless transaction device 102. In one example, a public key, for instance an account number or any other unique identifier, and a private key may be stored in the memory of the contactless transaction device 102 or otherwise associated therewith. Access to and/or knowledge of the private key may be limited, such as to manufacturers, vendors, service providers, authorized requestors, device holders, and the like. When transacting with the contactless transaction device 102, such as requesting consumer account data or medical data, or when attempting to upload information, the public key and the private key may be verified before access to information and/or data is stored on the device. For instance, application programming associated with a requestor device may conduct at least part of the public key and private key verification, and/or application programming stored on the microchip of the contactless transaction device 102 may conduct at least part of the public key and private key verification, using any suitable algorithm or technique to verify, encrypt, and/or decrypt authorization information.

With reference again to FIG. 1, the medical information reader 104 may be operated by an emergency responder I 18 for conducting a medical information transaction request with a contactless transaction device 102 storing medical data. An emergency responder 118 may include, but is not limited to, an emergency medical service technician, an ambulance operator, a physician, a law enforcement officer, a fireman, a disaster response unit, a pharmacist, and the like. Although referenced as an “emergency” responder, the contactless transaction device 102 may be used to retrieve medical data stored thereon in any situation, and is not limited to retrieval during an emergency event. The medical information reader 104 may be any transaction terminal operable to wirelessly communicate with the contactless transaction device 102, such as a handheld RFID reader or near field communication (“NFC”) reader. In another embodiment, the medical information reader 104 may be any other transaction device suitable for wirelessly communicating with the contactless transaction device 102, such as a personal computer, a mobile computer, a handheld portable computer, a digital assistant, a personal digital assistant, a cellular phone, a mobile phone, a smart phone, a pager, a digital tablet, a desktop computer, a laptop computer, an Internet appliance, or any other processor-based device, and the like. In yet another embodiment, the transaction terminal may be a terminal suitable for wired communication and/or magnetic communication, such as a POS terminal with a magnetic strip reader or bar code scanner operable for reading data from a magnetic strip or bar code of a typical payment card, loyalty card, membership card, and the like.

The medical information reader 102 may include at least one processor 120, a memory 122, and one or more input/output (“I/O”) interface(s) 124. The memory 122 may store data files and various software program modules, such as a medical information application program 126 for facilitating communications with one or more contactless transaction devices 102, and optionally for facilitating communications over a network with one or more service providers 112. The medical information application 126 may further include instructions for verifying the authority of the emergency responder 118 to access information on and/or transmit information to the contactless transaction device 102. Authority may be determined using various techniques, such as such as a PIN, a password, verification of a public and private key pair, whereby the account number or any other unique number may be used as the public key, a biometric indicator, voice verification, image verification, and the like. The memory may also store an operating system (“OS”), such as, but not limited to, Microsoft Windows®, Apple OSX™, or Linux, and a database management system (“DBMS”) to facilitate management of data files and data stored in the memory 122, for example.

The I/O interfaces 124 may include contactless transaction device reader hardware for transmitting to and/or requesting information from the contactless transaction device 102. Examples of device reader hardware may include, but are not limited to, RFID transceivers and/or other RFID communication devices, Bluetooth transceivers and/or other Bluetooth communication devices, infrared transceivers and/or other infrared communication devices, and/or NFC devices. In other example embodiments, the device reader hardware may include a magnetic strip reader and/or a bar code reader for reading information from transaction devices and/or products having data stored on a magnetic strip or coded in a bar code. The I/O interfaces 124 may also facilitate communication between the medical information reader 104 and one or more input/output devices, for example, a display, keyboard, keypad, mouse, control panel, touch screen display, microphone, and the like, that facilitate user interaction with the medical information reader 104. The one or more input/output devices may be utilized to collect information from any user of the medical information reader 104, for example, an emergency responder 118. The I/O interfaces 124 may also facilitate connection of the medical information reader 104 to one or more suitable networks 108, for example, a local area network, a wide area network, the Internet, an intranet, a telephone network, a cellular network, and the like. Additionally, other components may be included in the medical information reader 104 as desired in various embodiments of the invention.

With reference again to FIG. 1, the POS terminal/device 106 may be any suitable transaction device for facilitating the collection of information from the contactless transaction device 102, for example during processing of a typical payment transaction at a retailer. The POS terminal/device 106 may be any processor-driven device or plurality of devices operable to process a transaction at a point of sale, such as a personal computer, a mobile computer, a handheld portable computer, a digital assistant, a personal digital assistant, a cellular phone, a mobile phone, a smart phone, a pager, a digital tablet, a desktop computer, a laptop computer, an Internet appliance, or any other processor-based device. The POS terminal/device 106 may include at least one processor 130, a memory 132, and one or more input/output (“I/O”) interface(s) 134. The memory 132 may store data files and various software program modules, such as a consumer transaction application program 136 for processing any number of typical consumer transactions, such as a payment transaction or a loyalty transaction. The memory 132 may also include an operating system (“OS”), such as, but not limited to, Microsoft Windows®, Apple OSX™, or Linux, and a database management system (“DBMS”) to facilitate management of data files and data stored in the memory 132, for example. The consumer transaction application 136 may receive information associated with a transaction, for example, information associated with the consumer account data store on the contactless transaction device 102 when presented as a payment instrument. The consumer transaction application 136 may additionally operate in conjunction with one or more of the I/O interfaces 134 to facilitate communication with one or more other components of the system 100, such as, one or more financial institutions 110, which may include a payment processors, an issuer, a bank, and the like, and/or with one or more third party data sources.

The I/O interfaces 134 may include contactless transaction device reader hardware for transmitting to and/or requesting information from the contactless transaction device 102. Examples of device reader hardware may include, but are not limited to, RFID transceivers and/or other RFID communication devices, Bluetooth transceivers and/or other Bluetooth communication devices, infrared transceivers and/or other infrared communication devices, and/or NFC devices. In other example embodiments, the device reader hardware may include a magnetic strip reader and/or a bar code reader for reading information from transaction devices and/or products having data stored on a magnetic strip or coded in a bar code. The 1/O interfaces 134 may also facilitate communication between the POS terminal 106 and one or more input/output devices, for example, a display, keyboard, keypad, mouse, control panel, touch screen display, microphone, and the like, that facilitate user interaction with the POS terminal 106. The one or more input/output devices may be utilized to collect information from any user of the POS terminal 106, for example, a retail agent or store clerk 138 operating the terminal during a payment transaction, or the device holder 116 providing a personalized identification number or other verification information. The I/O interfaces 134 may also facilitate connection of the POS terminal 106 to one or more suitable networks 108, for example, a local area network, a wide area network, the Internet, an intranet, a telephone network, a cellular network, and the like. Additionally, other components may be included in the POS terminal 106 as desired in various embodiments of the invention.

The medical information terminal 114 may be any suitable transaction device for entering and/or updating information on the contactless transaction device 102, for example when entering or updating medical data on a contactless transaction device 102 by the device holder 116. The medical information terminal 114 may be any processor-driven device or plurality of devices operable to receive user input and communicate with a contactless transaction device 102, such as a personal computer, a mobile computer, a handheld portable computer, a digital assistant, a personal digital assistant, a cellular phone, a mobile phone, a smart phone, a pager, a digital tablet, a desktop computer, a laptop computer, an Internet appliance, or any other processor-based device. The medical information terminal 114 may include at least one processor 140, a memory 142, and one or more input/output (“I/O”) interface(s) 144. The memory 142 may store data files and various software program modules, such as medical data entry application program 146 for receiving medical data input and transmitting the medical data entry and or updates to the contactless transaction device 102. The memory 142 may also include an operating system (“OS”), such as, but not limited to, Microsoft Windows®, Apple OSX™, or Linux, and a database management system (“DBMS”) to facilitate management of data files and data stored in the memory 142, for example. The medical data entry application 146 may receive medical data input from the device holder 116 (e.g., updates or additions to pre-stored, default medical data), and transmit the medical data updates to the contactless transaction device 102. The medical data entry application 146 may further include instructions for verifying the authority of a device holder 116 to access information on and/or transmit information to the contactless transaction device 102 Authority may be determined using various techniques, such as such as a PIN, a password, verification of a public and private key pair, whereby the account number or any other unique number may be used as the public key, a biometric indicator, voice verification, image verification, and the like. The medical data entry application 146 may additionally operate in conjunction with one or more of the I/O interfaces 144 to facilitate communication with one or more other components of the system 100, such as, one or more service providers 112, which may store and manage medical data or other information remotely.

The I/O interfaces 144 may include contactless transaction device reader hardware for transmitting to and/or requesting information from the contactless transaction device 102. Examples of device reader hardware may include, but are not limited to, RFID transceivers and/or other RFID communication devices, Bluetooth transceivers and/or other Bluetooth communication devices, infrared transceivers and/or other infrared communication devices, and/or NFC devices. In other example embodiments, the device reader hardware may include a magnetic strip reader and/or a bar code reader for reading information from transaction devices and/or products having data stored on a magnetic strip or coded in a bar code. The I/O interfaces 144 may also facilitate communication between the medical information terminal 114 and one or more input/output devices, for example, a display, keyboard, keypad, mouse, control panel, touch screen display, microphone, and the like, that facilitate user interaction with the medical information terminal 114. The one or more input/output devices may be utilized to collect information from any user of the medical information terminal 114, for example, a device holder 116 when entering update medical data for transmission to the contactless transaction device 102. The I/O interfaces 144 may also facilitate connection of the medical information terminal 114 to one or more suitable networks 108, for example, a local area network, a wide area network, the Internet, an intranet, a telephone network, a cellular network, and the like. Additionally, other components may be included in the medical information terminal 114 as desired in various embodiments of the invention.

As mentioned, the system 100 may optionally include one or more financial institutions 110 that include any number of suitable processing systems and/or processing devices in communication with the POS terminals 106 over a network 108, to facilitate processing a consumer transaction, such as a payment. A financial institution 110 may be a third party payment processor, a bank, an issuer, or any combination thereof that may participate in processing a consumer transaction. The POS terminals 106 and the one or more financial institutions 110 may be in communication over a public network, such as the Internet or a telephone network, or a private network, such as a private bank network. In certain embodiments of the invention, the one or more financial institutions 110 may include one or more systems and/or devices that facilitate back-end processing of a transaction, such as one or more credit card processing systems, one or more debit card processing systems, one or more stored value card processing systems, one or more card issuers, and the like. Each of the one or more financial institutions 110 may include an appropriate processor driven device that facilitates processing of a transaction.

The system 100 may also optionally include one or more service providers 112 that include any number of suitable processing systems and/or processing devices in communication with one or more of the medical information reader devices 104, the POS terminals 106, and/or the medical information terminals 114. In one example embodiment, the service provider system 112 may facilitate medical data information inquiry and/or update transactions. For example, the service provider system 112 may include a medical information database management system 150 in communication with a data store 152 for remote storage and management of medical information. Thus, in embodiments including one or more service providers 112, the contactless transaction device may simply store a unique identifier, such as an account number, a condition code, a condition abbreviation, or any other unique identifier, which may be used by the medical information reader 104 and/or the medical information terminal 114 to request and/or update data stored by one or more service providers 112 and associated with the unique identifier(s). Similarly, a POS terminal 106 may also interface with one or more service providers 112, such as in embodiments in which the POS terminal 106 is used to access and/or update medical data stored on or in association with the contactless transaction device 102.

Generally, each of the memories 122, 132, 142, and data store 152, and any other data storage devices or databases, can store data and information for subsequent retrieval. In this manner, the system 100 can store various received or collected information in memory or a database associated with a medical information reader 104, a POS terminal 106, a medical information terminal 114, a service provider system 112, and/or a financial institution system 110. The memories 122, 132, 142, and data store 152, and any other data storage devices or databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the data store 152 and/or any other database shown can be integrated or distributed into any number of databases or data storage devices residing in association with one or more of the systems in the overall system 100.

Suitable processors for a medical information reader 104, a POS terminal 106, a medical information terminal 114, a service provider system 112, and/or a financial institution system 110 may include a microprocessor, an ASIC, and state machine. Example processors can be those provided by Intel Corporation (Santa Clara, Calif.), AMD Corporation (Sunnyvale, Calif.), and Motorola Corporation (Schaumburg, Ill.). Such processors include, or may be in communication with media, for example computer-readable media, which stores instructions that, when executed by the processor, cause the processor to perform the elements and/or functions described herein. Embodiments of computer-readable media include, but are not limited to, an electronic, optical, magnetic, or other storage or transmission device capable of providing a processor, such as the processors 120, 130, 140, or any other processors, for example those in used by the service provider systems 112 and/or the financial institution systems 110, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may include code from any computer-programming language, including, for example, C, C++, C#, Visual Basic, Java, Python, Perl, and JavaScript. Furthermore, any of the processors 120, 130, 140, or any other processors, for example those in used by the service provider systems 112 and/or the financial institution systems 110, may operate any operating system capable of supporting a browser or browser-enabled application including, but not limited to, Microsoft Windows®, Apple OSX™, and Linux.

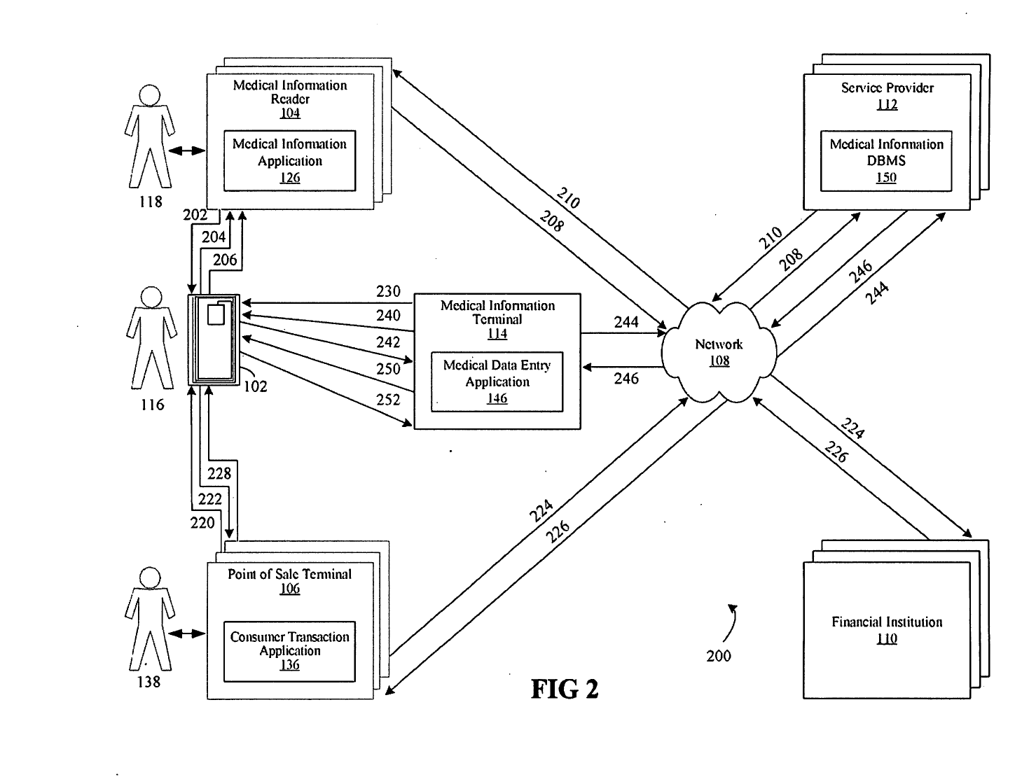

FIG. 2 shows an example data flow 200 between the components and entities shown associated with the system 100 for facilitating access to medical information using a contactless transaction device in accordance with an example embodiment of the invention. As described according to one embodiment, a device holder 116 may carry with them or wear a contactless transaction device 102 that stores both consumer data and medical data. An emergency responder 118 may also carry or otherwise have access to a medical information reader 104 when responding to an emergency event involving the device holder 116, such as a 9-1-1 emergency call. When arriving on the scene of an emergency event, the emergency responder 118 identifies that the device holder 116 has the contactless transaction device 102. The emergency responder 118 may then instruct the medical information reader 104 and its associated medical information application 126 to send a medical information request 202 to the contactless transaction device 102, for example by way of radio frequency communication when the medical information reader 104 is in proximity to the contactless transaction device 102 to energize the microchip and cause medical data processing. In response, the contactless transaction device 102 may transmit 204 some or all of the medical data stored in its memory to the medical information reader 104, such as medical history information, one or more medical conditions, allergy information, medication information, patient information, and/or physician information. The medical information reader 104 may display on a user interface the medical data to the emergency responder 118, allowing for the administration of the appropriate medical treatment given the device holder's conditions or other medical data stored on the contactless transaction device.

In one example embodiment, the contactless transaction device 102 may transmit 206 only a unique identifier in response to a medical information request 202, such as an account number, account id, or condition code, that is associated with remotely stored medical data. In response to receiving a unique identifier, the medical information reader 104 and its medical information application 126 may perform one or more additional data requests 208, such as over a network 108 to a service provider 112, to retrieve additional medical data stored remotely. In response to receiving the additional data request 208, the service provider 112 may perform a query within the medical information DBMS 150 or within one or more other data stores, based on the unique identifier transmitted 206 from the contactless transaction device 102 to the medical information reader 104 and to the service provider 112. Upon retrieving additional medical data, the service provider 112 may respond 210 with the additional medical data over the network 108 to the medical information reader 104.

In another example embodiment in which the contactless transaction device 206 transmits 206 only a unique identifier in response to a medical information request 202, the medical information reader 104 and the medical information application 126 may have medical data stored in memory or in a local data store which is retrievable by the medical information reader 104 based upon the unique identifier transmitted 206 from the contactless transaction device 102. For example, the medical information reader 104 may store general medical conditions, allergies, medications, and the like, in memory, and the contactless transaction device 102 may only store an associated identifier, code, or abbreviation.

Any of the additional data requests 208 (or internal) may be performed automatically by the medical information application 126, in response to receiving 206 unique identifiers from the contactless transaction device 102, or may be performed manually in response to instructions from the emergency responder 118.

In example embodiments, authorization information, such as a password, personal identification number, and the like, for verifying the authority of the requestor (e.g., the emergency responder 118 and/or the medical information reader 104) to access the device holder's medical data may be processed. Authorization information may be unique to the user (e.g., each emergency responder 118), unique to the device (e.g., each medical information reader 104), or unique to the device owner (e.g., each entity owning or controlling the emergency responder 118 or the medical information reader 104). The authorization processing may be performed within the medical information device reader 104 by the medical information application 126, such as by requesting authorization information from the emergency responder 118 (which may be unique to the emergency responder 118, unique to the medical information reader 104, or to the owning entity) and verifying it against information stored in memory on the reader 104. In another embodiment, the medical information reader 104 may request authorization information which is verified with a service provider 112 over a network 108. In yet another embodiment, the medical information reader 104 may also transmit authorization information to the contactless transaction device 102 for verification processing by the microchip. The authorization information may be entered by the emergency responder 118 or may be stored on the reader 104 and automatically transmitted by the medical information application 126. Upon processing by the microchip, an authorization response (e.g., yes/no, 0/1, valid/invalid, etc.) is transmitted to the medical information reader 104. When used, the authorization information is processed prior to allowing an emergency responder 118 to access or otherwise read medical data associated with the device holder 116 from the contactless transaction device. Authorization information may be verified prior to receiving 204 medical data or receiving 206 a unique identifier, or it may be verified after, but prior to displaying the data to the emergency responder 118.

With reference again to FIG. 2, in one embodiment the contactless transaction device 102 is operable to facilitate processing a consumer account transaction with a POS terminal 106, such as a payment at a retailer or merchant terminal. For example, when processing a payment transaction in which the device holder 116 presents the contactless transaction device 102 as a payment instrument, a POS terminal 106 and its consumer transaction application 136 may transmit 220 a request for consumer account data, such as account number, expiration data, balance, limit, and the like, from the contactless transaction device 102. The request for consumer account data may be transmitted 220 by way of radio frequency communication when the contactless transaction device 102 is in proximity to the POS terminal 106, energizing the microchip and causing consumer account transaction processing. In response, the contactless transaction device 102 may transmit 222 some or all of the consumer account data, for example an account number, stored in its memory to the POS terminal 106. Upon receiving 222 the consumer account data, the POS terminal 106 and its consumer transaction application 136 may perform payment transaction processing with a financial institution 110, as is known, such as with a payment processor, a card issuer, and/or a bank, for example. During the payment transaction processing, the POS terminal 106 may transmit 224 the consumer account data and any additional transaction information, such as transaction amount, store information, product information, and the like, to the financial institution 10 via a network 108. In response, the financial institution 110 may transmit 226 to the POS terminal 106 via the network 108 a processing authorization signal, which may include an approval or denial, an authorization code, a balance update, and the like. In one example embodiment, the POS terminal 106 may transmit 228 consumer account update information to the contactless transaction device 102, such as updating a balance or recording transaction details, for example. It is appreciated, however, that example contactless transaction devices 102 may only store account information, such as an account number, and that no other consumer account information is stored and/or updated on the contactless transaction device 102.

According to one example embodiment, during a consumer account transaction the authority of device holder 116 to use the contactless transaction device 102 as a payment instrument is verified. Thus, when conducting a consumer account transaction, the POS terminal 106 and its consumer transaction application 136 may request authorization information from the device holder 116, such as a password, personal identification number, and the like. In one embodiment, upon entry of the authorization information, the POS terminal 106 may transmit the authorization information to the contactless transaction device 102 for verification. A response (e.g., yes/no, 0/1, valid/invalid, etc.) may then be transmitted from the contactless transaction device 102 to the POS terminal 106. However, in another embodiment, the contactless transaction device I 02 may transmit authorization information, such as a password or personal identification number, when transmitting 222 the consumer account data in response to the original request 220 by the POS terminal 106. In this embodiment, the consumer transaction application 136 may then verify whether or not the device holder 116 provided a correct password, personal identification number, or the like.

In one embodiment, the contactless transaction device 102 may be operable to transmit at multiple frequencies or frequency ranges, which may be used to increase the security to read data from and/or store data on the contactless transaction device 102. For example, the contactless transaction device 102 may be operable to communicate consumer account data during a conventional consumer account transaction, such as at a POS terminal 106, over a first frequency or frequency range, and operable to communicate medical data over a second frequency or frequency range. Similarly, a medical information reader 104 or medical information terminal 114 may be operable to communicate only over the second frequency or frequency range, while a POS terminal 106 may be operable to communicate only over the first frequency or frequency range (for example, approximately 13.56 MHz according to the ISO/IEC 14443 standard). Thus, according to this example embodiment, a POS terminal 106 may not improperly access medical data stored on the contactless transaction device 102 and a medical information reader 104 or a medical information terminal l 14 may not improperly access consumer account data stored on the contactless transaction device 102 as a result of the different frequency ranges over which such data is transmitted. It is appreciated that the division of data being communicated at more than one frequency need not be made only between medical information and consumer account information, but any other division may occur, such as between varying levels of privacy or security associated with various medical information. This embodiment may be used to instead of or in addition to one or more authorization functions described herein.

With reference again to FIG. 2, in one embodiment the data stored on the contactless transaction device 102, such as medical data, may be updated by a medical information terminal 114 and its medical data entry application 146. For example, after a device holder 116 purchases or otherwise activates a contactless transaction device 102 operable to store medical data thereon, the device holder 116 may use a medical information terminal 114, such as a transaction terminal in a retailer or a personal computer, to enter medical data specific to medical conditions of the device holder 116. Thus, after the device holder 116 (or any other user) inputs or otherwise enters data into the medical information terminal 114, the medical information terminal 114 transmits 230 the entered or updated medical data to the contactless transaction device 102. The contactless transaction device 102 may respond with a status message (e.g., success/failure).

In one example embodiment in which the contactless transaction device 102 stores only an identifier associated with remotely stored medical data, such as data maintained at a service provider 112, upon entry of medical data by the device holder 116 to the medical information terminal 114, the medical information terminal 114 and its medical data entry application 146 transmit 240 a request for the unique identifier stored on the contactless transaction device, such as an account number. In response, the contactless transaction device 102 transmits 242 a unique identifier to the medical information terminal 114. The medical information terminal 114 and its medical data entry application 146 then transmit 244 the unique identifier with the updated medical data to the service provider 112 via a network 108, enabling the service provider 112 to update the medical data associated with the unique identifier, such as by using the medical information DBMS 150 to update one or more data stores. Upon updating the medical data, the service provider 112 may then respond 246 via the network 108 to the medical information terminal 114 with a status message (e.g., success/failure).

According to one example embodiment, the authority of the device holder 116 to enter and/or update medical data stored on or associated with the contactless transaction device 102 may be verified. Thus, when performing a medical data update transaction, the medical information terminal 114 and its medical data entry application 146 may request authorization information from the device holder 116, such as a password, personal identification number, verification of a public and private key pair, whereby the account number or any other unique number may be used as the public key, and the like. In one embodiment, upon entry of the authorization information, the medical information terminal 114 may transmit 250 the authorization information to the contactless transaction device 102 for verification. A response (e.g., yes/no, 0/1, valid/invalid, etc.) may then be transmitted 252 from the contactless transaction device 102 to the medical information terminal 114. However, in another embodiment the medical information terminal 114 may transmit authorization information, such as a password or personal identification number, when transmitting 230 the updated medical data during the original transmission. In another embodiment, the medical information terminal 114 may request authorization information from the contactless transaction device 102 to perform the verification by the medical data entry application 146. In yet another embodiment, the medical information terminal 114 may transmit the authorization information requested from the device holder 116 and a unique identifier to the service provider 112 via a network 108, and receive an authorization response (e.g., yes/no, 0/1, valid/invalid, etc.) from the service provider 112.

With each of the various transactions illustrated by the data flow 200, access to certain information (e.g., access to medical data versus consumer account data) stored on or associated with the contactless transaction device 102 may be limited. For example, when an emergency responder 118 is requesting 202 medical data using a medical information reader 104, one of the medical information application 126 or the microchip on the contactless transaction device 102 may verify whether the emergency responder 118 has authorization to access the medical data (as described above) and whether the emergency responder 118 has access to the consumer account data. In certain situations, an emergency responder may not have access to the consumer account data, and thus the contactless transaction device 102 will only transmit the medical data to the medical information reader 104 (or both medical data and consumer data is transmitted to the medical information reader 104, but the medical information application 126 limits the data displayable based on the authority of the emergency responder 118).

Moreover, according to some embodiments, different requestors may have varying levels of authority to access various medical data stored on or otherwise associated with the contactless transaction device 102. For example, if the requestor is an emergency responder 118, the responder may be permitted to only access patient-specific conditions, but may not be able to access other, more secure information, such as insurance information, provider information or consumer account data. Whereas, if the requester is a medical provider, such as a hospital administrator or physician, the requester may have access to greater medical data, such as insurance or provider information. These two examples of access are provided for illustrative purposes, and various additional levels of access to certain medical data or certain consumer data may be defined. In one embodiment, the contactless transaction device 102 may store indicators of access levels associated with different sets of authorization information, which may be verified when determining the requestor's authority: In another embodiment, a service provider may store indicators of access levels, which may be verified over a network when determining the requestor's authority. In yet another embodiment, the terminal requesting the information, such as the medical information reader 104 or the medical information terminal 114, may store one or more authorization files including indicators of access levels associated with the requestor's authority, which may be periodically updated. Thus, according to this embodiment, access to read and/or edit medical data and/or consumer account data stored on a contactless transaction device 102 may vary based on based on authorization information and access indicators verified while authorizing the requestor.

Similarly, when a contactless transaction device 102 is presented as a payment instrument to a POS terminal 106 and the terminal 106 requests 220 consumer account data, the authority of the terminal 106 and/or the terminal operator 138 to access stored medical data is verified. In certain situations, the POS terminal 106 and/or the operator 138 will only have access to the consumer account data, and thus the contactless transaction device 102 and/or the consumer transaction application 136 will limit the access to and/or display of information to the consumer account data.

In addition, when the device holder 116 uses a medical information terminal 114 and medical data entry application 146 to enter and/or update medical data on or associated with the contactless transaction device, the device holder 116 may not be allowed to access or update consumer account data. Thus, the medical data entry application 146 of the contactless transaction device 102 may be operable to receive and verify the authority of the device holder 116 and limit privileges to consumer account data accordingly.

In example embodiments, some or all of the data transmitted between entities in the system, as described by the systems 100 and the data flow 200 illustrated in FIGS. 1 and 2, may be encrypted to increase security and maintain privacy of the information. The security of financial account information is paramount to avoid fraud, particularly when performing electronic payment transactions. In addition, the transmission and/or sharing of certain patient, prescription, and/or other medically related information may be restricted by law and/or by the various participating entities. For example, the Health Insurance Portability and Accountability Act (“HIPAA”) was enacted by U.S. Congress establishing national standards for protecting the security and privacy of health data. Accordingly, one or more of the transmissions of consumer data and/or medical data discussed herein, such as consumer account numbers, medical conditions, patient information, medication information, may include additional security measures as is acceptable by the participating entities and under the governing laws and regulations. As described, certain data may be password protected, the systems may include administrative functions that include unique user identification for any person and/or entity operating and/or accessing the systems, that vary access to certain data based on user roles and responsibilities, and that can terminate user access to one or more of the systems. Additionally, certain medical data transmitted that may be classified as “protected health information” (e.g., patient, prescription, and/or other medically related information tied to a patient) and sensitive consumer account data may be encrypted prior to transmission using acceptable encryption techniques, as are known (e.g., SSL encryption). Thus, the medical information application 126, medical data entry application 146, consumer transaction application 136, medical information DBMS 150, and/or any other data processing, communication, and storage systems, as described herein that may be executed by one or more of the above described entities to transmit or receive consumer account data and/or medical data, may include an encryption/decryption module and/or a user access administration module to satisfy the security and privacy of financial account information and protected health information.

One skilled in the art may recognize the applicability of embodiments of the invention to other environments, contexts, and applications. One will appreciate that components of the system 100 and data flow 200 shown in and described with respect to FIGS. 1 and 2 are provided by way of example only. Numerous other operating environments, system architectures, device configurations, and data flows are possible. Accordingly, embodiments of the invention should not be construed as being limited to any particular operating environment, system architecture, device configuration, or data flow.

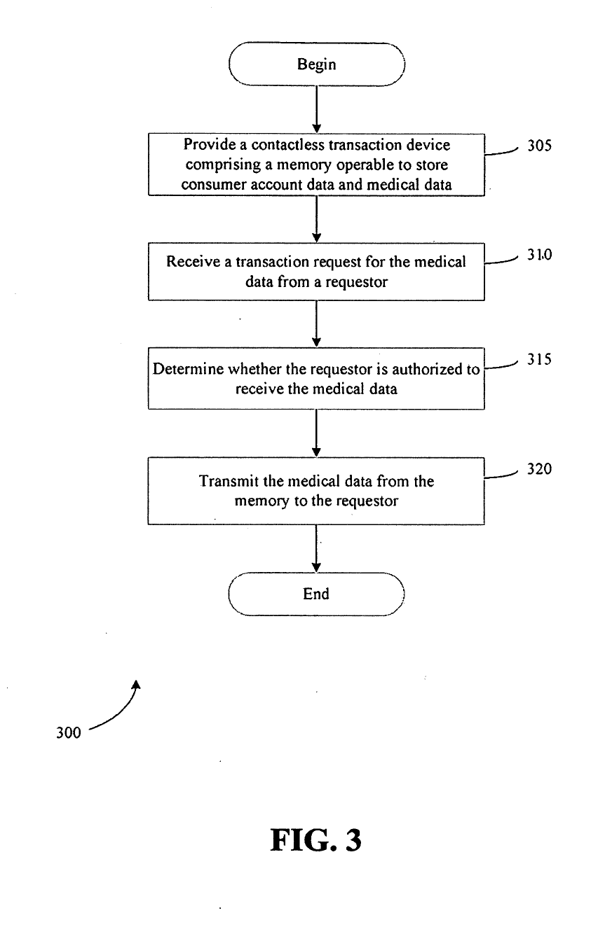

FIG. 3 is a flowchart of one example method 300 for facilitating access to medical information using a contactless transaction device 102 in accordance with various embodiments of the invention. The method 300 may include receiving a transaction request by a contactless card 102, then transmitting the medical data to the requestor if the requestor is authorized to receive the medical data. The example method 300 may be performed in situations, such as emergency situations, in which an emergency responder identifies that the subject is carrying, wearing, or otherwise possesses a contactless transaction device 102 that may store medical data or have medical data associated therewith, which may be useful in administering appropriate medical treatment.

The method 300 may begin at block 305. At block 305, a contactless transaction device 102, which includes a memory operable to store both consumer account data and medical data, is possessed by a device holder 116.

Following block 305 is block 310, in which an emergency responder 118 requests medical data from the contactless transaction device 102 upon recognizing its possession by the device holder 1 6. The emergency responder 118 may use a medical information reader, such as the medical information reader 104 as described with reference to FIGS. 1 and 2, to electronically request medical data from the contactless transaction device. In an example embodiment in which the contactless transaction device 102 is RFID enabled, placing the contactless transaction device 102 in proximity to the medical information reader 104 and activating a radio frequency request may energize the microchip of the contactless transaction device 102 and cause it to process the request.

As part of the request, block 315 depicts that the authority of the requester is verified to determine whether the requester is authorized to receive or otherwise access the medical data. The authorization processing may be performed by the medical information reader 104 or by the contactless transaction device 102, as described with reference to FIG. 2. The authorization processing may be performed automatically, such as during the request for medical data, or manually, such as by entering authorization information prior to requesting medical data. Also as described above, it may be the emergency responder 118 whose authorization is verified, or it may be the medical information reader or an entity owning or controlling the reader that is verified. It is further appreciated that the authorization may not be performed at all, or may only be performed periodically, such as once a day, hourly, upon power-up of the device, and the like, so as to provide quick response by the emergency responder but to also occasionally verify that the requester is still an authorized requestor.

Upon determining the authority of the requestor at block 315 follows block 320, in which the contactless transaction device 102 transmits the medical data from its memory to the medical information reader 104 to display or otherwise make available to the emergency responder 118. As described with reference to FIG. 2, the medical data stored on the contactless transaction device 102 and transmitted at least in part to the medical information reader 104 at block 320 may include, but is not limited to, patient medical histories, medical conditions, allergy information, medication information, patient information, physician information, and the like. In one embodiment, however, the medical data stored on the contactless transaction device 102 may be only one or more unique identifiers, such as an account number or code, associated with remotely stored data, which may be transmitted to the medical information reader 104 at block 320. Upon receiving one or more unique identifiers, the medical information reader 104 may then query a service provider 112, or perform an internal look-up, to obtain medical data associated with the unique identifier(s).

The method 300 may end following block 320.

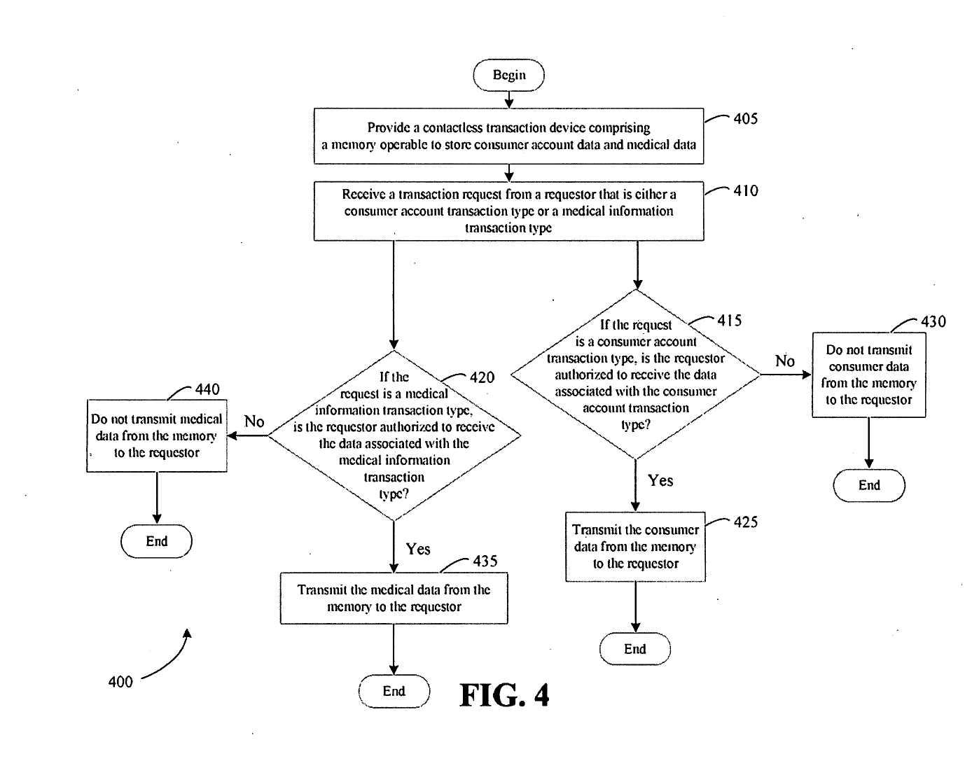

FIG. 4 is a flowchart of one example method 400 for facilitating access to medical information using a contactless transaction device 102 in accordance with various embodiments of the invention. As illustrated in FIG. 4, when conducting a transaction using a contactless transaction device 102 storing both consumer account data and medical data, example embodiments may limit the access of certain requesters to one or the other type of data. For example, when conducting a consumer account transaction, such as when the contactless transaction device 102 is presented to tender payment for a purchase, access to the medical data stored on the device by the POS terminal and/or the terminal operator may be limited or completely prevented. This may be beneficial to avoid patient data privacy concerns. In another example, when an emergency responder is requesting medical data from a contactless transaction device 102, such as is described by example with reference to FIG. 3, the emergency responder may be prevented from accessing the consumer account data stored on the contactless transaction device to maintain financial account security.

The method 400 may begin at block 405. At block 405, a contactless transaction device 102, which includes a memory operable to store both consumer account data and medical data, is provided when conducting a transaction. The transaction may be a consumer account transaction, such as a payment transaction, loyalty transaction, and the like; or the transaction may be a medical data transaction, such as when an emergency responder is requesting medical data that may be stored on the contactless transaction device when providing emergency medical treatment. If the transaction is a consumer account transaction, the contactless transaction device 102 may by placed in proximity to a device reader to process the transaction, such as one associated with a POS terminal 106, as described with reference to FIGS. 1 and 2. If the transaction is a medical data transaction, an emergency responder may place a medical information reader, such as the medical information reader 104 described with reference to FIGS. 1 and 2, in proximity to the contactless transaction device to begin the data request processing.

At block 410, which follows block 405, the contactless transaction device 102 will receive a transaction request for data from the requester. In an example embodiment in which the contactless transaction device 102 is RFID enabled, placing the contactless transaction device 102 in proximity to the requestor (e.g., the POS terminal 106 or the medical information reader 104) and activating a radio frequency request may energize the microchip of the contactless transaction device 102 and cause it to process the request. In other embodiments, other techniques of wirelessly communicating with the contactless transaction device 102 may be used. In yet other embodiments, the requester may read data from a magnetic strip or a bar code on the contactless transaction device 102.

As described, the transaction request may be a consumer account transaction request, such as requesting an account number, a balance, a limit, or other account information; or the transaction request may be for medical data stored on or associated with the contactless transaction device 102.

Following block 410 are blocks 415 and 420, in which it is determined whether the requester is authorized to access data associated with the transaction request being made.

If the transaction request is a request for consumer account information, at block 415 it is determined whether the requester is authorized to receive or otherwise access the consumer account data associated with the transaction request. For example, a POS terminal 106 and/or clerk 138 operating the terminal when processing a payment using the contactless transaction device 102 may typically be authorized to see consumer account data. However, an emergency responder may not be authorized to see such consumer account data stored on or associated with the contactless device 102, and thus access may be limited.

If it is determined at block 415 that the requester is authorized to receive consumer account data, such as during a payment transaction request transmitted by an authorized POS terminal 106, block 425 follows, in which the contactless card device 102 will transmit consumer account data in response to the transaction request at block 410. However, if it is determined at block 415 that the requester is not authorized to receive consumer account data, such as an emergency responder requesting consumer account data via a medical information reader 104, block 430 follows in which the contactless card does not transmit consumer account data in response to the transaction request at block 410.

In one example embodiment, the authorization verification may be performed on the contactless transaction device 102, such as verification of a personal identification number, password, and the like, transmitted by the requestor. In another example, the authorization verification may be performed at or by the requestor device, such as by a consumer transaction application 136 or a medical information application 126. In one example embodiment, at block 430 the contactless transaction device 102 does not transmit consumer account information unless the requestor's authority is verified. In another embodiment, however, the consumer account data may be transmitted to the requester, for example data may be transmitted to the consumer transaction application 136, but is not displayed, accessed, or otherwise used if it is determined that the requestor is not authorized. Similarly, the contactless transaction device 102 may transmit medical data along with consumer account data in response to a consumer account transaction request, but the consumer transaction application 136 can prevent display, access, or use of the medical data if unauthorized.

Similar to block 415, if the transaction request from block 410 is a request for medical data, at block 420 it is determined whether the requester is authorized to receive or otherwise access the medical data associated with the transaction request. For example, an emergency responder and/or handheld medical information reader 104 may have authorization to access medical data stored on the contactless transaction device 102. However, a POS terminal 104 and/or clerk 138 operating the terminal when processing a payment using the contactless transaction device 102 may not be authorized to access medical data stored on or associated with the contactless device, and thus access may be limited.

If it is determined at block. 420 that the requestor is authorized to receive medical data, such as an emergency responder requesting medical data using a medical information reader 104, block 435 follows, in which the contactless card device 102 will transmit medical data in response to the transaction request at block 410. However, if it is determined at block 420 that the requester is not authorized to receive medical data, such as if the responder and/or medical information reader 104 do not have valid authorization information, or when processing a payment using the contactless transaction device 102, block 440 follows in which the contactless transaction device 102 does not transmit medical data in response to the transaction request at block 410. Accordingly, the authorization determination performed at block 420 may determine whether an emergency responder is appropriately authorized, or prevent a clerk and/or POS terminal 106 from receiving sensitive medical during a consumer account transaction. In one embodiment, the authorization determination performed at block 420 may serve to properly restrict access in accordance patient privacy guidelines.

Like at block 415, the authorization verification may be performed on the contactless transaction device 102, such as verification of a personal identification number, password, and the like, transmitted by the requestor; or it may be performed at or by the requester device, such as by a medical information application 126. In one example embodiment, at block 435 the contactless transaction device 102 does not transmit medical data unless the requestor is verified. In another embodiment, however, the medical data may be transmitted to the requester, for example the data is transmitted to the medical information application 126, but is not displayed, accessed, or otherwise used if it is determined that the requestor is not authorized. Similarly, the contactless transaction device 102 may transmit consumer account data along with medical data in response to a medical data request, but the medical information application 126 can prevent display, access, or use of the consumer account data if unauthorized.

The method 400 may end following any of blocks 425, 430, 435, or 440.

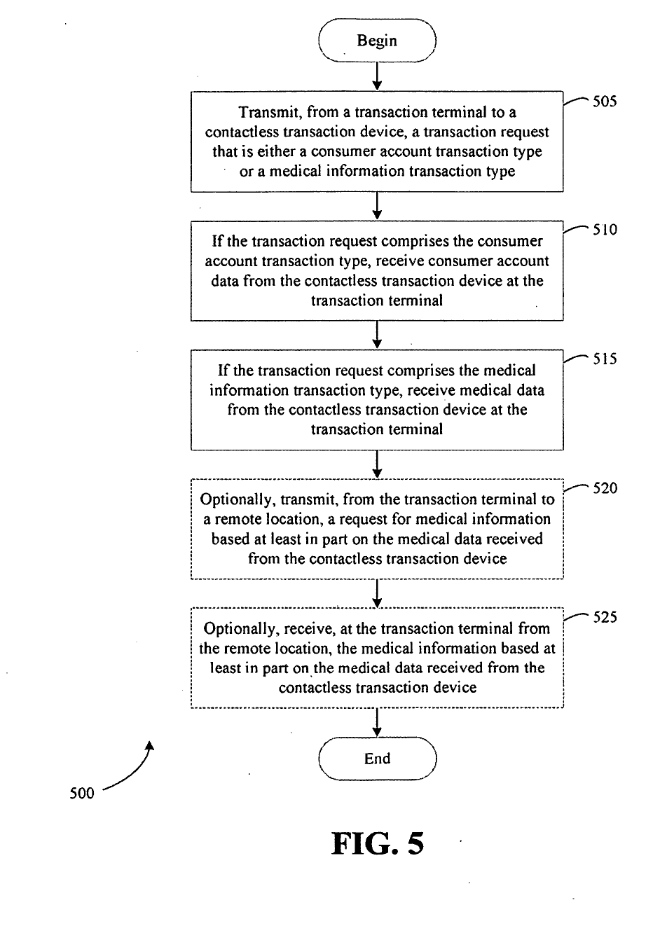

FIG. 5 is a flowchart of one example method 500 for using a transaction terminal to access medical data and/or consumer account data from a contactless transaction device 102 in accordance with various embodiments of the invention.

The method 500 may begin at block 505, in which a transaction terminal transmits a transaction request for medical data and/or consumer account data stored on or associated with the contactless transaction device 102. In one example, the transaction terminal may be a medical information reader 104, as described with reference to FIGS. 1 and 2, and the transaction request may be for medical data, such as when responding to an emergency situation. In another embodiment, the transaction terminal may be a POS terminal 106, as described with reference to FIGS. 1 and 2, and the transaction request may be for consumer account data, such as when processing a payment using the contactless transaction device 102.

Following block 505 is block 510, in which consumer account data is transmitted if the transaction request is for consumer account information. In example embodiments, at least one of the contactless transaction device and/or the transaction terminal may verify whether the requester is authorized to receive the consumer account information. In addition, during a consumer account transaction, the transaction terminal may also request authorization from information from the device holder, such as a personal identification number, a password, verification of a public and private key pair, whereby the account number or any other unique number may be used as the public key, and the like, before processing the consumer account transaction. These example authorization verification procedures may be performed by the transaction terminal alone or may be performed in association with authorization requests transmitted to a third party, such as a financial institution.

Similarly, following block 510 is block 515, in which medical data is transmitted if the transaction request is for medical information. In example embodiments, the authority of the emergency responder and/or terminal may be verified by the contactless transaction device and/or the transaction terminal may verify whether the requestor is authorized to receive the medical data. These example authorization verification procedures may be performed by the transaction terminal alone or may be performed in association with authorization requests transmitted to a third party, such as a service provider.

Blocks 520 and 525 optionally follow block 515. In response to the transaction requests performed at block 505, one or more unique identifiers may be returned from the contactless transaction device 102 at block 515 that facilitate access to remotely stored medical data associated with the one or more unique identifiers. Thus, a contactless transaction device 102 may only store a few elements of information, such as one or more of a medical data account identifier, medical condition identifier, a medical condition code, an account number, and the like, each of which may relate to medical data stored in a remote location. In other embodiments in which the contactless transaction device 102 stores and transmits actual medical data rather than or in addition to a unique identifier, the transaction terminal may still request additional information from a service provider, such as to supplement or verify the medical data transmitted from the contactless transaction device.

Accordingly, at block 520, upon receiving medical data, such as one or more unique identifiers, at block 515, the transaction terminal may then request from the remote location, such as a service provider, additional medical data associated with the one or more unique identifiers transmitted from the contactless transaction device 102. For example, a medical information reader 104 may wirelessly transmit (e.g., over a cellular or Wi-Fi network) a medical information account number to the service provider, facilitating the service provider to retrieve stored medical data associated with the account number. In one embodiment, the transaction terminal may automatically transmit the request for additional information upon receiving medical data from the contactless transaction device 102. Though, in other embodiments, the operator of the transaction terminal may manually cause the terminal to transmit the request for additional medical information.

At block 525, the transaction terminal may receive additional medical data from the remote location, such as from the service provider, based on the request transmitted at block 520. In one embodiment, the service provider may verify the requestor's authority to access the medical data prior to responding, such as by requesting and verifying a personal identification number, a password, and the like.

The method 500 may end after block 525, after receiving additional medical information from the remote location.

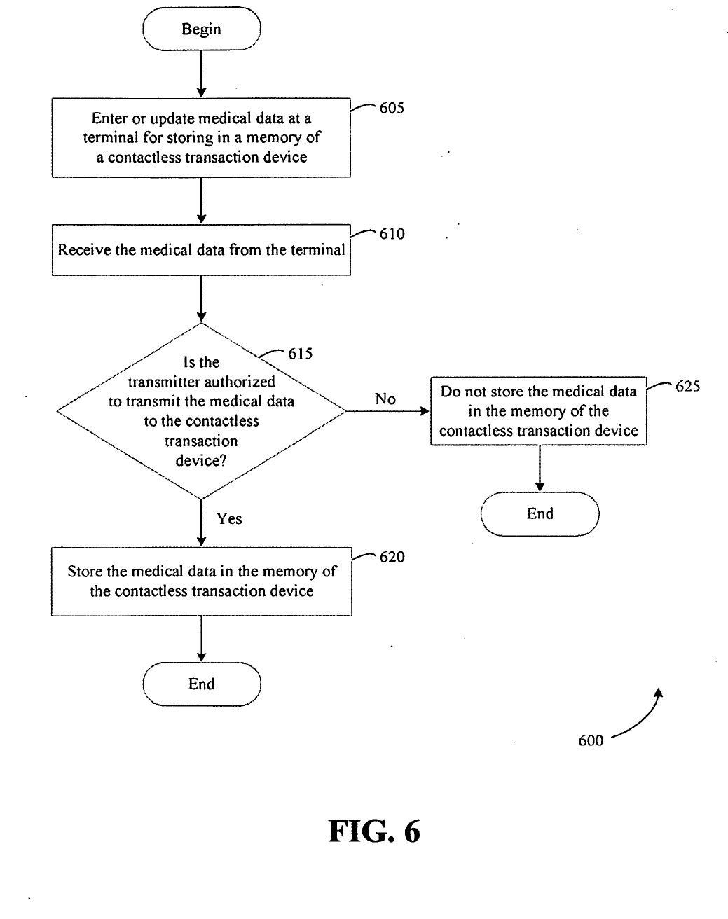

FIG. 6 is a flowchart of one example method 600 for using a transaction terminal to enter and/or update medical data stored on a contactless transaction device 102 in accordance with various embodiments of the invention. A contactless transaction device 102 storing medical data may be updatable to allow a device holder to enter, update, customize, change, add, or otherwise alter medical information stored thereon. For example, some contactless transaction devices 102 may be sold without any medical information stored, allowing for a device holder to enter medical information customized to suit his or her own medical conditions. In other example embodiments, contactless transaction devices 102 may be sold with one or more pre-stored default medical conditions, but still allow the device holder to update, add, delete, or otherwise alter the medical data.

The method 600 may begin at block 605, in which a transmitter, such as a device holder, a sales clerk, a terminal operator, enters or updates medical data into a transaction terminal for storing in a memory of a contactless transaction device 102. For simplicity, the example method 600 refers to a device holder as the transmitter, though any other transmitter may enter and/or update medical data. The transaction terminal may be any typical transaction terminal operable to receive and wirelessly transmit device holder input, such as the medical information terminal 114 and its medical data entry application 146 described with reference to FIGS. 1 and 2, like a retailer POS terminal, a personal computer, a mobile computer, a handheld portable computer, a digital assistant, a personal digital assistant, a cellular phone, a mobile phone, a smart phone, a pager, a digital tablet, a desktop computer, a laptop computer, an Internet appliance, or any other processor-based device, and the like. In another example embodiment, the transaction terminal may be operable to receive device holder input, and to communicate the input via a network to a service provider, such as the service provider 112 described with reference to FIGS. 1 and 2.

At block 605, the device holder may enter new or additional medical data to be stored on the contactless transaction device 102, update medical data already stored on the contactless transaction device 102, and/or delete medical data already stored on the contactless transaction device 102. Medical data that may be added or altered includes, but is not limited to, medical history information, one or more medical conditions, allergy information, medication information, patient information, and/or physician information.

In one example embodiment, the medical information terminal 114 and its medical data entry application 146 may initially read medical information already stored on the contactless transaction device 102 and present it to the device holder via a user interface at block 605. Thus, the device holder may be able to view data already existing on the contactless transaction device 102 and enter, update, or otherwise alter accordingly via the medical data entry application 146 software module.

Following block 605 is block 610, in which the contactless transaction device 102 receives the medical data from the transaction terminal entered by the device holder at block 605. In an example embodiment in which the contactless transaction device 102 is RFID enabled, placing the contactless transaction device 102 in proximity to the transaction terminal and activating a radio frequency request by the terminal may energize the microchip of the contactless transaction device 102 and cause it to receive the medical data and begin processing the update request. In other embodiments, other techniques of wirelessly communicating with the contactless transaction device 102 may be used. In yet other embodiments, the requester may read data from a magnetic strip or a bar code on the contactless transaction device 102.

Following block 610 is decision block 615, in which the transmitter's authority to transmit medical data to the contactless transaction device 102 is verified by the contactless transaction device 102 and/or the transaction terminal. In one example embodiment, the authority of the device holder entering the information may be verified, such as by requesting and verifying a personal identification number, a password, verification of a public and private key pair, whereby the account number or any other unique number may be used as the public key, and the like. In another example, the authority of the clerk to operate the transaction terminal may be verified, for example if the device holder requests an update to medical data via a POS terminal at a retailer or merchant site. In yet another example, the authority of the actual transaction terminal may be verified by the contactless transaction device 102 verifying that the transaction terminal is properly authorized. Verifying the authority of the transmitter may be performed by the transaction terminal, by the contactless transaction device 102 alone, a combination of both, and/or may be performed in association with authorization requests transmitted to a third party, such as a service provider 112 as described with reference to FIGS. 1 and 2.

In one example embodiment, authorization information for entering or updating medical data may be transmitted between the transaction terminal and the contactless transaction device 102 at a different frequency or different frequency range than other communications (such as conventional commercial transactions) between the two. Thus, authorization information for entering or storing data on the contactless transaction device may only be communicated by terminals operable to communicate in the different frequency or frequency range, increasing the security of the contactless transaction device 102 and limiting the access to enter or update data stored thereon.

If it is determined that the transmitter is authorized to transmit medical data to the contactless transaction device 102 at decision block 615, block 620 follows, in which the contactless transaction device 102 may store the medical data in its memory. New medical data may be added to any existing medical data, and existing medical data may be updated or deleted. The medical data entry application 146 of a medical information terminal 114 may perform the read, write, delete, and/or update processing at block 620.

Conversely, if it is determined that the transmitter is not authorized to transmit medical data to the contactless transaction device 102 at decision block 615, block 625 follows, in which the medical data is not stored in memory of the contactless transaction device 102. In one example embodiment, the medical data entry application 146 of the medical information terminal 114 may display a status reject message, indicating to the device holder that the authority verification failed, which may in turn prompt the device holder to re-enter authorization information, re-transmit information to the device, and the like.

In one example embodiment, the transaction terminal may verify the transmitter's authority prior to transmitting medical data to the contactless transaction device, which would cause decision block 615 and resulting blocks 620 and 625 to occur prior to block 610.

In another embodiment, the medical data entered at block 605 for entry or update on the contactless transaction device 102 may be transmitted to a service provider or other entity and later downloaded onto a terminal for storing on the device at a later time. For example, a user may enter medical data at a terminal at a merchant or retailer, or may otherwise instruct a terminal operator to enter the medical data, and the medical data may be transmitted over a network to a service provider, such as the service provider 112. The medical data may be associated with a unique identifier already stored on or otherwise associated with the contactless transaction device 102, allowing for subsequent retrieval at the same or a different terminal. Then, at a later time, the user may request the medical data from the service provider 112 over a network via another terminal, such as the medical information terminal 114. Upon receiving the medical data from the service provider 112, the user may attempt to store the medical data in a memory of the contactless transaction device 102 using the medical information terminal 114, as described above. Accordingly, a merchant, retailer, service provider, or any other entity may facilitate an entry and/or update of medical data for a contactless transaction device, which may be made available to the device user over a network at a subsequent time.

The method 600 may end after blocks 620 or 625, after medical data is entered or updated on the contactdess transaction device if the transmitter is so authorized.

The operations described and shown in the methods of FIGS. 3-6 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 36 may be performed.

The invention is described above with reference to block diagrams and flowchart illustrations of systems, methods, apparatuses and computer program products according to embodiments of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions above.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams and flowchart illustrations support combinations of means for performing the specified functions, combinations of elements or steps for performing the specified functions and program instruction means for performing the specified functions. It will also be understood that each block of the block diagrams, and combinations of blocks in the block diagrams, can be implemented by special purpose hardware-based computer systems that perform the specified functions, elements or steps, or combinations of special purpose hardware and computer instructions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A contactless transaction device for facilitating access to medical information, comprising:
an antenna operable to electromagnetically receive and transmit data;
a microchip in communication with the antenna, the microchip comprising a memory operable to store consumer account data and medical data, wherein in association with a transaction using the contactless transaction device, the microchip is operable to:
receive a transaction request from a requestor via the antenna, wherein the transaction request comprises either a consumer account transaction type or a medical information transaction type;
separately determine whether the requestor is authorized to receive the consumer account data and whether the requestor is authorized to receive the medical data;
if the transaction request comprises the consumer account transaction type and if the requestor is authorized to receive the consumer account data, transmit the consumer account data from the memory to the requestor via the antenna; and
if the transaction request comprises the medical information transaction type and if the requestor is authorized to receive the medical data, transmit the medical data from the memory to the requestor via the antenna.

2. The contactless transaction device of claim 1, wherein if the transaction request comprises the medical information transaction type and if the requestor is not authorized to receive the medical data, the microchip is further operable to not transmit medical data to the requestor responsive to the determination.

3. The contactless transaction device of claim 1, wherein the consumer account data comprises at least one of: financial account information, loyalty account information, or consumer information.

4. The contactless transaction device of claim 1, wherein the medical data comprises at least one of: a medical condition identifier, a medical information identifier, a medical information account identifier, or patient information.

5. The contactless transaction device of claim 1, wherein the medical data comprises a name associated with a medical condition.

6. The contactless transaction device of claim 1, wherein the transaction request comprises the medical information transaction type, and wherein the medical data comprises a medical information account identifier that facilitates the requestor to retrieve medical information stored remotely.

7. The contactless transaction device of claim 1, wherein, in association with a transaction using the contactless transaction device, the microchip is further operable to:
receive medical data to store in the memory from a transmitter via the antenna;
determine whether the transmitter is authorized to transmit the medical data; and
if the transmitter is authorized to transmit the medical data, store the medical data in the memory.

8. The contactless transaction device of claim 7, wherein the requestor and the transmitter are associated with the same entity.

9. The contactless transaction device of claim 7, wherein at least a portion of the medical data is encrypted prior to receipt by the contactless transaction device.

10. The contactless transaction device of claim 1, wherein the microchip is further operable to encrypt at least a portion of the medical data stored in the memory.

11. The contactless transaction device of claim 1, wherein the microchip is further operable to communicate at a plurality of frequencies, wherein a first data type is communicated at a first frequency and a second data type is communicated at a second frequency.

12. A method of transmitting medical data stored on a contactless transaction device, comprising:
providing a contactless transaction device comprising: an antenna, and a microchip comprising a memory in communication with the antenna, the memory operable to store consumer account data and medical data;
receiving a transaction request from a requestor via the antenna wherein the transaction request comprises either a consumer account transaction type or a medical information transaction type;
separately determining whether the requestor is authorized to receive the consumer account data and whether the requestor is authorized to receive the medical data;
if the transaction request comprises the consumer account transaction type and if the requestor is authorized to receive the consumer account data, transmitting the consumer account data from the memory to the requestor via the antenna; and
if the transaction request comprises the medical information transaction type and if the requestor is authorized to receive the medical data, transmitting the medical data from the memory to the requestor via the antenna.

13. The method of claim 12, wherein the consumer account data comprises at least one of: financial account information, loyalty account information, or consumer information.

14. The method of claim 12, wherein the medical data comprises at least one of: a medical condition identifier, a medical information identifier, a medical information account identifier, or patient information.

15. The method of claim 12, wherein the transaction request comprises the medical information transaction type, and wherein the medical data comprises a medical information account identifier that facilitates the requestor to retrieve medical information stored remotely.

16. The method of claim 12, further comprising determining that the requestor is not authorized to receive the consumer data, and not transmitting the consumer data when transmitting the medical data.

17. The method of claim 12, farther comprising determining that the requestor is not authorized to receive the medical data, and not transmitting the medical data when transmitting the consumer data.

18. The method of claim 12, wherein determining whether the requestor is authorized to receive the consumer account data and whether the requestor is authorized to receive the medical data is performed at least in part by the microchip.

19. The method of claim 12, wherein the transaction request transmitted by the requestor further comprises authorization information used at least in part to determine whether the requestor is authorized to receive data associated with the transaction request.

20. The method of claim 12, further comprising:
receiving medical data to store in the memory on the contactless transaction device from a transmitter via the antenna;
determining whether the transmitter is authorized to transmit the medical data; and
storing the medical data in the memory responsive to determining that the transmitter is authorized to transmit the medical data.

21. The method of claim 20, further comprising entering the medical data for storing in the memory on the contactless transaction device at a terminal associated with the transmitter and in communication with the contactless transaction device.

22. The method of claim 20, wherein determining whether the transmitter is authorized to transmit the medical data further comprises validating a private key associated with the contactless transaction device.

23. The method of claim 20, further comprising:
entering updated medical data for storing in the memory on the contactless transaction device at a terminal associated with the transmitter and in communication with the contactless transaction device;
receiving the updated medical data from the terminal;
determining whether the transmitter is authorized to transmit the updated medical data; and
storing the updated medical data in the memory responsive to determining that the transmitter is authorized to transmit the updated medical data.

24. The method of claim 20, wherein at least a portion of the medical data is encrypted prior to receipt by the contactless transaction device.

26. The method of claim 12, further comprising encrypting at least a portion of the medical data stored in the memory.

27. A method of accessing medical data stored on a contactless transaction device, comprising:
transmitting, from a transaction terminal to a contactless transaction device, a transaction request comprising either a consumer account transaction type or a medical information transaction type, wherein the transaction request comprises authorization information for separately authorizing, by the contactless transaction device, whether the transaction terminal is authorized to receive the consumer account data and whether the requestor is authorized to receive the medical data;
if the transaction request comprises the consumer account transaction type, receiving consumer account data from the contactless transaction device, responsive to a determination that the transaction terminal is authorized to receive the consumer account data; and
if the transaction request comprises the medical information transaction type, receiving medical data from the contactless transaction device, responsive to a determination that the transaction terminal is authorized to receive the medical account data.

28. The method of claim 27, wherein the transaction request comprises the medical information transaction type, wherein the medical data comprises a medical information account identifier associated with medical information stored at a remote location, and further comprising:
transmitting, from the transaction terminal to the remote location, a request for the medical information associated with the medical information account identifier; and
receiving, at the transaction terminal from the remote location, the medical information responsive to the request.
